(19) United States
(12) Patent Application Publication
(10) Pub. No.: US 2026/0241955 A1
(43) Pub. Date: Aug. 20, 2026

(54) METHOD FOR GENERATING TEST DATA FOR A SIMULATION OF AN ASSISTANCE SYSTEM OF AN AT LEAST PARTIALLY ASSISTED MOTOR VEHICLE, COMPUTER PROGRAM PRODUCT, COMPUTER-READABLE STORAGE MEDIUM AND ELECTRONIC COMPUTING DEVICE

(71) Applicant: MERCEDES-BENZ GROUP AG, Stuttgart (DE)

(72) Inventors: Zafer KAYATAS, Stuttgart (DE); Pascal BESTLE, Steinenbronn (DE)

(21) Appl. No.: 19/153,646

(22) PCT Filed: Jan. 14, 2024
(86) PCT No.: PCT/EP2024/050743

§ 371 Date: Aug. 5, 2025

(30) Foreign Application Priority Data
Feb. 6, 2023 (DE) 10 2023 000 357.3

(51) Int. Cl. B60W 60/00; G06N 3/0455

(52) U.S. Cl. CPC B60W 60/0011; G06N 3/0455

(57) ABSTRACT

Test data for simulating an assistance system of a partially assisted motor vehicle involves specifying real recorded trajectory data of at least one driving situation for the at least partially assisted driving operation of the motor vehicle. Training trajectories are extracted from the trajectory data. A variable autoencoder is trained with the extracted training trajectories. Potential test data for the simulation is generated by the trained variable autoencoder. The real recorded trajectory data is compared with the potential test data and test data for the simulation is identified depending on the comparison.

### BACKGROUND AND SUMMARY OF THE INVENTION

Exemplary embodiments of the invention relate to a method for generating test data for a simulation of an assistance system of an at least partially assisted motor vehicle by means of an electronic computing device, as well as to a computer program product, a computer-readable storage medium, and an electronic computing device.

The automated or assisted driving of motor vehicles is already known from the prior art. The motivations include improving safety, utilizing resources more efficiently and increasing comfort. Proving the safety of advanced driver assistance systems, such as highly automated driving, poses new challenges for validation and testing, as the usual approach to date, which focuses primarily on real test driving data, would require driving unreasonably long distances. By way of example, if one wants to test a system for emergency braking when another vehicle unexpectedly changes lanes on a motorway, the developers of such a system have to spend a lot of time recording enough of these situations on the road. The recorded situations are then used to test the driver assistance system. In addition, new challenges arise, such as the takeover situation between the system and the human driver.

In view of the above, simulation has proven to be a promising tool for the validation of driver assistance systems. In other words, simulation makes it possible to generate a set of trajectories of surrounding vehicles based on a limited number of real trajectories recorded during test drives. Real safety-relevant driving situations, in particular from the totality of the recorded data of the test drives, are selected and evaluated for their criticality. Such situations are then simulated. Simulation is understood here as the generation of a set of trajectories of one or more neighboring vehicles that come close to the real trajectories recorded during test drives, but represent a larger set of possible trajectories. The significance of the results depends heavily on how realistically the simulated test cases can reproduce real traffic situations.

US 2022/100635 A1 describes a validation of autonomous control software for the autonomous operation of a motor vehicle. By way of example, the autonomous control software is run through a driving scenario to observe a result for the autonomous control software. A validation model is run through the driving scenario multiple times to observe a result for the model for each of the multiple times. Whether the software has understood the driving scenario is determined by whether the result for the software indicates that a virtual vehicle controlled by the software has collided with another object during the single time period. Whether the validation model has understood the driving scenario is determined based on whether the result for the model indicates that a virtual vehicle under the control of the model has collided with another object at one of the multiple points in time. The software is validated based on the findings.

Exemplary embodiments of the present invention are directed to a method, a computer program product, a computer-readable storage medium, and an electronic computing device, by means of which an improved generation of test data for the electronic computing device can be implemented.

One aspect of the invention relates to a method for generating test data for a simulation of an assistance system of an at least partially assisted motor vehicle by means of an electronic computing device. Real recorded trajectory data of at least one driving situation is specified for the at least partially assisted driving operation of the motor vehicle. Training trajectories are extracted from the real trajectory data by means of the electronic computing device. A variable autoencoder of the electronic computing device is trained with the extracted training trajectories. Potential test data for the simulation is generated using the trained variable autoencoder. The real recorded trajectory data is compared with the potential test data using the electronic computing device and test data is identified for the simulation depending on the comparison.

In particular, a novel approach based on artificial intelligence is proposed for generating realistic driving scenarios for the simulative validation of assistance systems. This increases both the quality of the simulative validation through realistic test cases and reduces the high complexity and effort required for the mathematical modelling of driving scenarios. In particular, it is therefore provided that instead of mathematical models and physical parameters, an Al model trained with real driving data, in particular the variable autoencoder, is used to generate driving scenarios for simulative validation. The invention is not limited to the development of a corresponding model for artificial intelligence, but also includes the complete workflow from the pre-processing of raw measurement data to the integration of the newly generated data into the entire simulation environment using the artificial intelligence model.

In particular, it can be provided that the potential test data and/or the test data are generated in such a way that they can be used to control a functional device of the assistance system. By way of example, an acceleration device, a braking device, a lateral acceleration device or a steering device can be regarded as a functional device. Furthermore, it can in particular also be provided that a functional device of the assistance system is controlled on the basis of the generated test data.

In particular, the generated data (test data) can thus be regarded as “functional data” for controlling a technical device, in particular the assistance system, if these are specially adapted for the purposes of their intended technical use. In particular, the actually generated test data can be used to control the assistance system, in particular corresponding parameters of the generated trajectory, in order to have a corresponding effect on the assistance system, in particular on driving the motor vehicle. By way of example, the driver assistance system can be designed to control a speed, an acceleration, a braking system or even as a steering wheel.

It is also advantageous that the test data is extracted using a classifier of the electronic computing device. In order to have sufficient data for training the autoencoder in particular, measurement series of test drives are used, from which consecutive sequences are extracted using a sliding window method, for example, which can then be pre-processed. In particular, a so-called classifier is then used to recognize safety-relevant situations and cut these out to form a training set. Marked/labelled data representing safety-relevant situations is used to train the classifier. The training can be carried out with real historical data, i.e., the real trajectory data, or with simulated data. In the end, the classifier is trained with the lateral position trajectories in order to recognize the safety-critical situations and to cut out the trajectory-relevant objects, in particular those that cause safety-relevant scenarios, with their trajectories.

It is furthermore advantageous if trajectory data is filtered so that unphysical behavior of at least one road user in the real recorded trajectory data is removed. By way of example, objects in the trajectory data with a short duration of existence can be identified as ghost objects and filtered out. It can also be provided that the real trajectory data is compared with the potential test data in terms of quality and quantity. In particular, the quality of the generated data therefore depends heavily on the quality of the data used to train the autoencoder. Comprehensive pre-processing of the data is therefore the basis for good performance when generating new data for the simulation. Pre-processing refers to all transformations of the raw data. The starting point is, for example, the selection of suitable measurement signals to characterize the movements of the objects contained in the measurement. L-shapes based on the analysis of sensor data are used to identify the movement of the traffic objects relative to the ego-vehicle, in particular the motor vehicle equipped with the corresponding sensors.

A cascade of different filters, for example min-max filters, Savitzky-Golay filters, is then used to smooth the measurement data and remove unphysical behavior, for example through signal jumps. In addition, measurement sections with a low density of available measurements and therefore greater uncertainty are ignored and objects with only a short period of existence are identified as ghost objects and filtered out.

In particular, the presented method is a computer-implemented method. Therefore, a further aspect of the invention relates to a computer program product having program code means which cause an electronic computing device to perform a method according to the preceding aspect as the program code means are processed by the electronic computing device.

A further aspect of the invention relates to a computer-readable storage medium having the computer program product.

Furthermore, the invention also relates to an electronic computing device for generating test data for a simulation of an assistance system of an at least partially assisted motor vehicle, having at least one variable autoencoder, wherein the electronic computing device is designed to carry out a method according to the preceding aspect. In particular, the method is carried out by means of the electronic computing device.

The electronic computing device has, for example, processors, circuits, in particular integrated circuits, and other electronic components in order to be able to carry out corresponding method steps.

Advantageous embodiments of the method are also to be regarded as advantageous embodiments of the electronic computing device. The electronic computing device has, for example, objective features in order to be able to carry out corresponding method steps.

Further advantages, features and details of the invention emerge from the following description of preferred exemplary embodiments and from the drawings. The features and combinations of features mentioned in the description above and the features and combinations of features mentioned in the description of figures below and/or only shown in the figures can be used not only in the combination indicated in each case, but also in other combinations or on their own without leaving the scope of the invention.

### BRIEF DESCRIPTION OF THE DRAWING FIGURES

Here are shown:

FIG. 1 a schematic plan view of an embodiment of a motor vehicle having an embodiment of an assistance system having an embodiment of an electronic computing device;

FIG. 2 a schematic flow chart according to an embodiment of the method;

FIG. 3 a schematic block diagram according to an embodiment of a variable autoencoder;

FIG. 4 a schematic plan view of a scenario having an embodiment of a motor vehicle; and

FIG. 5 a schematic diagram for a data analysis.

In the figures, identical or functionally identical elements are provided with identical reference numerals.

### DETAILED DESCRIPTION

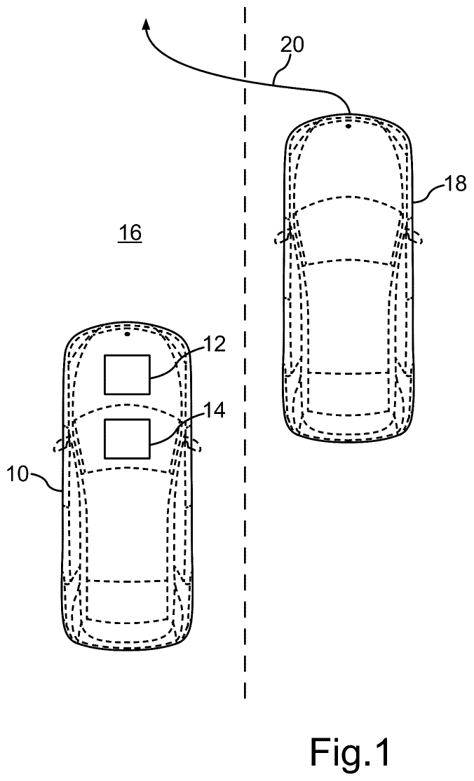

FIG. 1 shows a schematic plan view of an embodiment of a motor vehicle 10. The motor vehicle 10 is operated in an at least partially assisted manner. The motor vehicle 10 can also be operated fully assisted. For this purpose, the motor vehicle 10 has, in particular, an assistance system 12. In particular, the assistance system 12 has an electronic computing device 14.

In particular, an object is formed in an environment 16 of the motor vehicle 10, which is represented below in particular as a further motor vehicle 18. The additional motor vehicle 18 has a trajectory 20 which, for example, runs along the track of the motor vehicle 10. This could be a safety-critical situation, for example emergency braking situations, in which the assistance system 12 has to react accordingly when the motor vehicle 10 is in the at least partially assisted driving mode.

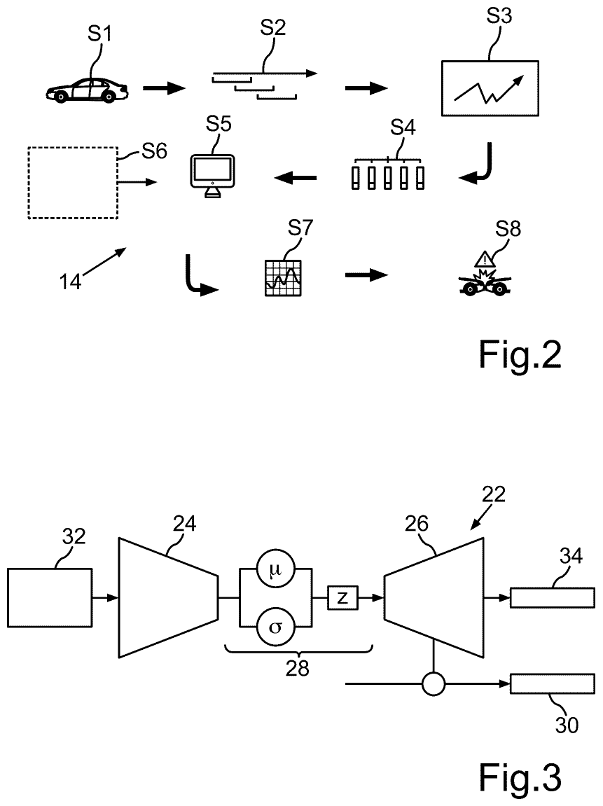

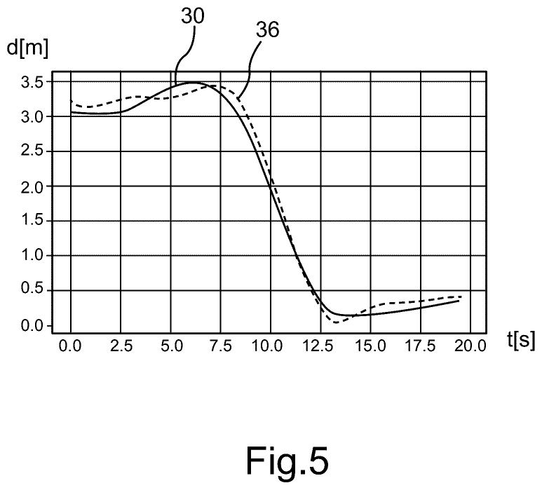

FIG. 2 shows a schematic flow chart according to an embodiment of the method. In a first step S1, real recorded trajectory data 36 (see FIG. 5), for example the trajectory data 20, of the object are recorded by measurement. In a second step S2, sequences of the measurements are extracted. In a third step S3, the measurement signals are pre-processed, in particular the identification of non-physical behavior and so-called ghost objects. In a fourth step S4, the objects are classified, in particular by means of a classifier that is trained with labelled simulation data. In a fifth step S5, data is then generated with the variable autoencoder 22 (FIG. 3) for the specific object class. It can additionally be provided that in a sixth step S6, a qualitative and quantitative evaluation of the corresponding data takes place, for example with hyperparameter optimization. In a seventh step S7, the integration into the existing simulation is then carried out. In the eighth step S8, the generated test data is then simulated and, in particular, its safety-critical evaluation is also carried out.

FIG. 3 shows a schematic block diagram according to an embodiment of a variable autoencoder 22. The variable autoencoder 22 has at least one encoder 24 and one decoder 26, wherein both the encoder 24 and the decoder 26 can be designed as a folded neural network. Furthermore, a so-called latent space 28 is shown. In particular, multivariate data of time series are processed in the encoder 24, and a reconstruction 34 takes place in the decoder 26. The test data 30 can be generated based on the reconstruction 24 and the latent space 28.

In particular, FIG. 3 shows the variable autoencoder 22, which is used as the basic architecture of the artificial neural network to generate the test data 30. The autoencoder 22 consists of two substantial parts, in particular the encoder 24 and the decoder 26. These are trained to replicate the input data by transforming the input in a low-dimensional latent space 28, which corresponds in particular to the encoder part, and reconstructing the input from this latent space 28, which corresponds in particular to the decoder part. The encoder of a variable autoencoder 22 differs from that of a regular autoencoder in that it can map the input data as a multivariate latent distribution. A sample is then drawn from this distribution and passed through the decoder 26, which creates a faithful reconstruction 34 of the input data. The new data can be generated by passing randomly drawn encodings through the decoder 26.

For the generative model, multidimensional time series 32 are provided, which represent a particular challenge due to the temporal dependencies within the signals. The use of convolutional neural networks, which are usually used for image data, has proven to be a promising way of overcoming this particular challenge. Alternatively, deep neural networks or recurrent neural networks can also be used. The architecture of the network and the learning process are optimized using hyperparameter optimization in the form of a grid search.

To evaluate the performance of the autoencoder 22, in particular how realistic the generated synthetic data is, both qualitative and quantitative techniques are used for validation. To date, there is no standard method for evaluating the performance of generative neural networks when using time series signals as input data. In order to perform a differentiated and comprehensive evaluation, different characteristics of the data are taken into account and qualified using selected metrics specifically designed for these technical applications.

The overall distribution of new data points for each feature, neglecting the temporal aspect of the data and a kernel density estimate, are used to analyze whether the generated data cover the entirety of the input data.

Another metric, in particular autocorrelation, takes the temporal aspect into account. Autocorrelation is used to analyze whether the generated data represent the temporal dependencies of the test data 30. Specifically, autocorrelation is a correlation of a signal with a delayed version of itself. It measures the relationship between the current value of the signal and its original values.

Furthermore, a metric called MiVo (Mean of incoming Variance of outgoing) can also be used. This is based on distance measures using nearest neighbors for all training samples as well as for all generated samples. MiVo not only allows an assessment of how realistic the generated data is, but also how diverse it is. Test data 30 generated for a specific scenario is then used to test the reaction of the assistance system 12 to this scenario.

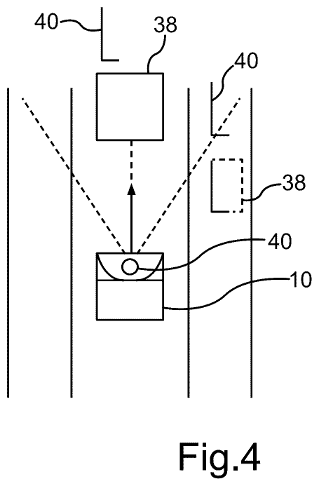

FIG. 4 shows a schematic plan view of a scenario with one embodiment of the motor vehicle 10. In particular, an L-shape is shown based on the analysis of sensor data from one sensor 40 or a plurality of sensors 40. Due to the restricted field of view, a sensor 40 perceives the surrounding other motor vehicles 38 as the rear and one of the side surfaces (depending on which side the surrounding vehicle was facing the sensor during the maneuver). The perceived image is reminiscent of the letter L and is referred to as an L-shape 40. L-shapes 40 based on the analysis of sensor data are used to identify the movement of traffic objects relative to the ego-vehicle, in particular the motor vehicle 10 equipped with the corresponding sensors 40.

FIG. 5 a schematic diagram for a data analysis. In particular, FIG. 5 shows, for example, a lane change maneuver. The time t in [s] is plotted on the X-axis and a lateral distance d in [m] is plotted on the Y-axis. The real recorded trajectory data 36 is represented with a dashed line and the test data 30 with a solid line. The trajectories of the neighboring motor vehicles are represented in relation to the motor vehicle 10.

In particular, a distribution of the points of the training data set can be compared with the distribution of the trajectory points of the generated set. These are similar, but not. The offshoots belong to the safety-relevant scenarios that correspond to realistic behavior of neighboring motor vehicles, but which was not recorded during real test drives.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
specifying real recorded trajectory data of at least one driving situation for an at least partially assisted driving operation of a motor vehicle having an assistance system;
extracting, by an electronic computing device, training trajectories from the real recorded trajectory data;
training a variable autoencoder of the electronic computing device with the extracted training trajectories;
generating, using the trained variable autoencoder, potential test data used to simulate the assistance system;
comparing, by the electronic computing device, the real recorded trajectory data with the potential test data; and
identifying, based on the comparing of the real recorded trajectory data with the potential test data, test data.

12. The method of claim 11, wherein the potential test data or the test data is generated in such a way that the potential test data or the test data enable a functional device of the assistance system to be controlled.

13. The method of claim 12, further comprising:
controlling the functional device of the assistance system using the test data.

14. The method of claim 11, wherein the training trajectories are extracted by a classifier of the electronic computing device.

15. The method of claim 11, further comprising:
filtering the extracted training trajectories such that a non-physical behavior of at least one object is removed in the real recorded trajectory data.

16. The method of claim 15, wherein objects in the trajectory data with only a short period of existence compared to other objects are identified as ghost objects and filtered out.

17. The method of claim 11, wherein the real recorded trajectory data are qualitatively and quantitatively compared with the potential test data.

18. A non-transitory computer-readable storage medium having a computer program product containing program code, which when executed by an electronic computing device cause the electronic computing device to:
specify real recorded trajectory data of at least one driving situation for an at least partially assisted driving operation of a motor vehicle having an assistance system;
extract training trajectories from the real recorded trajectory data;
train a variable autoencoder of the electronic computing device with the extracted training trajectories;
generate, using the trained variable autoencoder, potential test data used to simulate the assistance system;
compare the real recorded trajectory data with the potential test data; and
identify, based on the comparing of the real recorded trajectory data with the potential test data, test data.

19. An electronic computing device configured to:
specify real recorded trajectory data of at least one driving situation for an at least partially assisted driving operation of a motor vehicle having an assistance system;
extract training trajectories from the real recorded trajectory data;
train a variable autoencoder of the electronic computing device with the extracted training trajectories;
generate, using the trained variable autoencoder, potential test data used to simulate the assistance system;
compare the real recorded trajectory data with the potential test data; and
identify, based on the comparing of the real recorded trajectory data with the potential test data, test data.
